(19) United States
(12) Patent Application Publication
(10) Pub. No.: US 2026/0087170 A1
(43) Pub. Date: Mar. 26, 2026

(54) TERMINAL DEVICE AND CONTROL METHOD

(71) Applicant: JVCKENWOOD Corporation, Yokohama-shi (JP)

(72) Inventor: Yusuke Shimizu, Yokohama-shi (JP)

(21) Appl. No.: 19/403,349

(22) Filed: Nov. 28, 2025

Related U.S. Application Data
(63) Continuation of application No. PCT/JP2024/019383, filed on May 27, 2024.

(30) Foreign Application Priority Data
May 30, 2023 (JP) 2023-088933
Mar. 13, 2024 (JP) 2024-038899

(51) Int. Cl. G06F 21/62; G06V 40/20

(52) U.S. Cl. CPC G06F 21/6245; G06V 40/28

(57) ABSTRACT

A terminal device includes: a display unit that displays information; a movement information obtaining unit that obtains movement information indicating a movement performed by a person with respect to the display unit which displays the information; a confidentiality-indicating-movement detecting unit that, based on the movement information obtained by the movement information obtaining unit, detects whether or not a movement performed by the person with respect to the display unit represents a confidentiality indicating movement; and a confidential region processing unit that, when the confidentiality-indicating-movement detecting unit detects the confidentiality indicating movement, decides on a confidential region based on the movement information obtained by the movement information obtaining unit, and generates a confidential video based on the confidential region.

### CROSS-REFERENCE TO RELATED APPLICATIONS

This application is a Continuation of PCT International Application No. PCT/JP2024/019383 filed on May 27, 2024 which claims the benefit of priority from Japanese Patent Application No. 2023-088933, filed on May 30, 2023 and Japanese Patent Application No. 2024-038899, filed on Mar. 13, 2024, the entire contents of all of which are incorporated herein by reference.

### BACKGROUND OF THE INVENTION

### 1. Field of the Invention

The application concerned relates to a terminal device and a control method.

### 2. Description of the Related Art

A technology has been disclosed by which, during an online meeting, at the time of sharing one's own screen to other persons, the confidential information included in the screen is kept confidential (for example, refer to Japanese Patent Application Laid-open No. 2015-191487).

However, in the technology disclosed in Japanese Patent Application Laid-open No. 2015-191487, the information that is to be kept confidential needs to be specified in advance. For that reason, in the technology disclosed in Japanese Patent Application Laid-open No. 2015-191487, in the case in which the information to be kept confidential is included in the screen to be shared, when that information is to be made confidential in an instant, there is a possibility of not being able to make the information confidential in an appropriate manner.

### SUMMARY OF THE INVENTION

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

A terminal device according to the present disclosure comprising: a display unit that displays information; a movement information obtaining unit that obtains movement information indicating a movement performed by a person with respect to the display unit which displays the information; a confidentiality-indicating-movement detecting unit that, based on the movement information, detects whether or not a movement performed by the person with respect to the display unit represents a confidentiality indicating movement; and a confidential region processing unit that, when the confidentiality-indicating-movement detecting unit detects the confidentiality indicating movement, decides on a confidential region based on the movement information obtained by the movement information obtaining unit, and generates a confidential video based on the confidential region.

A control method according to the present disclosure comprising: obtaining movement information that indicates a movement performed by a person with respect to a display unit which displays information; detecting, based on the movement information, whether or not a movement performed by the person with respect to the display unit represents a confidentiality indicating movement; and generating that, when the confidentiality indicating movement is detected, includes deciding on a confidential region based on the movement information, and generating a confidential video based on the confidential region.

### BRIEF DESCRIPTION OF THE DRAWINGS

FIG. 1 is a diagram for explaining a presentation system according to an embodiment;

FIG. 2 is a block diagram illustrating an exemplary configuration of a terminal device according to the embodiment;

FIG. 3 is a diagram for explaining a confidentiality indicating movement and confidentiality processing according to the embodiment;

FIG. 4 is a flowchart for explaining a flow of confidentiality processing according to the embodiment;

FIG. 5 is a diagram illustrating an example of confidential region information according to the embodiment;

FIG. 6 is a diagram for explaining the coordinates of a confidential region according to the embodiment;

FIG. 7 is a diagram for explaining a confidential video that is displayed in another terminal device according to the embodiment; and

FIG. 8 is a diagram for explaining a method for updating the confidential region according to the embodiment.

### DETAILED DESCRIPTION OF THE PREFERRED EMBODIMENTS

An exemplary embodiment of the application concerned is described in detail with reference to the accompanying drawings. However, the application concerned is not limited to the embodiment described below. In the embodiment described below, identical constituent elements are referred to by the same reference numerals, and their explanation is not given repeatedly.

### Embodiment

### Presentation System

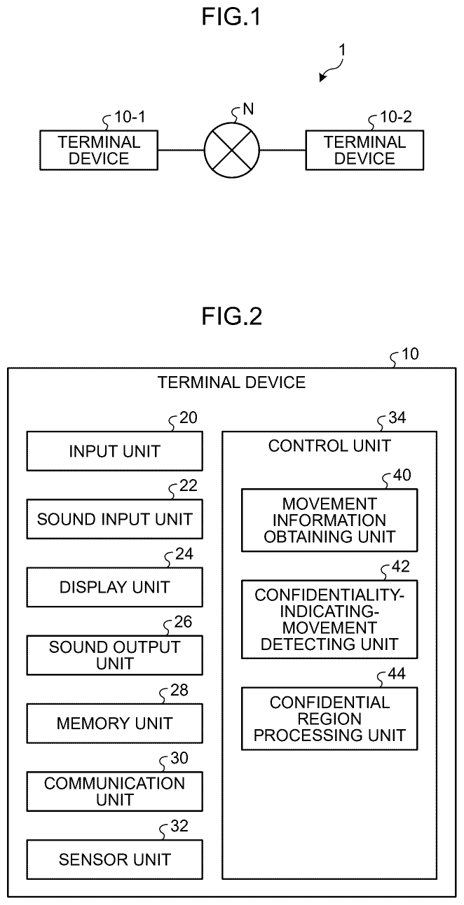

Explained below with reference to FIG. 1 is a presentation system according to the embodiment. FIG. 1 is a diagram for explaining the presentation system according to the embodiment.

As illustrated in FIG. 1, a presentation system 1 includes terminal devices 10-1 and 10-2. The terminal devices 10-1 and 10-2 are connected to each other in a communicable manner via a network N. The presentation system 1 enables holding an online meeting using the terminal devices 10-1 and 10-2. When the terminal devices 10-1 and 10-2 need not be distinguished from each other, they are collectively referred to as terminal devices 10. Although the presentation system 1 includes two terminal devices 10, the application concerned is not limited to that case. Thus, there can be three or more terminal devices 10 included in the presentation system 1. Meanwhile, in the example given below, although the explanation is given with reference to a presentation system, it is alternatively possible to use an online meeting system that shares information without involving presentation, or to use a system in which the content being displayed on the display screen of the terminal device 10-1 is displayed on the display screen of the terminal device 10-2. In that case, the terminal device 10-2 can be an external monitor or a projector.

For example, during an online meeting, in the case in which a presentation is being given while sharing some material, if confidential information such as a password is included in the shared material, it is common practice for the presenter to stop the screen sharing. However, in the presentation system 1, when confidential information is included in the shared material, if the presenter performs an instant movement such as covering the display screen of the corresponding terminal device 10 by a hand, the confidential information is prevented from being displayed on the display screen of the other terminal device 10.

### Terminal Device

Explained below with reference to FIG. 2 is an exemplary configuration of the terminal device 10 according to the embodiment. FIG. 2 is a block diagram illustrating an exemplary configuration of the terminal device according to the embodiment.

As illustrated in FIG. 2, the terminal device 10 includes an input unit 20, a sound input unit 22, a display unit 24, a sound output unit 26, a memory unit 28, a communication unit 30, a sensor unit 32, and a control unit 34. Examples of the terminal device 10 include, but are not limited to, a personal computer, a tablet terminal, a smartphone, a head mounted display (HMD), and a head up display (HUD).

The input unit 20 receives a variety of operations performed with respect to the terminal device 10. The input unit 20 can be implemented using a variety of input devices such as switches, buttons, or a touch-sensitive panel.

The sound input unit 22 detects the voice of the user of the terminal device 10. Then, the sound input unit 22 converts the detected voice into a voice signal. The sound input unit 22 is implemented using a microphone.

The display unit 24 is equipped with a display surface for displaying the information of a variety of images. For example, the display unit 24 is used to display the material being shared during an online meeting. The display unit 24 is implemented using, for example, a light emitting diode (LED) display or an organic electro-luminescence (EL) display. When the input unit 20 is configured with a touch-sensitive panel, the input unit 20 and the display unit 24 are configured in an integrated manner. When the terminal device 10 is a device such as an HUD that projects the image information, the display unit 24 need not be equipped with a display surface.

The sound output unit 26 is a speaker that outputs a variety of sounds. For example, the sound output unit 26 outputs the voices of the users of the other terminal devices 10 participating in an online meeting.

The memory unit 28 stores therein a variety of information. The memory unit 28 stores therein the operation details of the control unit 34 and information such as computer programs. The memory unit 28 includes at least either a main storage device such as a random access memory (RAM) or a read only memory (ROM), or an external storage device such as a hard disk drive (HDD).

The communication unit 30 is a communication interface that enables communication between the terminal device 10 and an external device. For example, the communication unit 30 enables communication between the terminal device 10 and an external sensor. Moreover, for example, the communication unit 30 enables communication between the terminal devices 10-1 and 10-2. The communication unit 30 is configured to be communicable using, for example, a wireless local area network (LAN), a wired LAN, or Wi-Fi (registered trademark).

The sensor unit 32 is a sensor for detecting the movements performed by the user of the terminal device 10. For example, the sensor unit 32 detects a movement performed by the user with respect to the display unit 24. More particularly, the sensor unit 32 detects a movement performed by the user with respect to the display surface of the display unit 24 using some body part. For example, the sensor unit 32 detects a movement performed by the user with respect to the display surface of the display unit 24 using the hands. The sensor unit 32 either can be configured in an integrated manner with the terminal device 10, or can be configured separately from the terminal device 10. The sensor unit 32 outputs movement information, which indicates a detected movement, to a movement information obtaining unit 40.

The sensor unit 32 can be, for example, a camera configured in an integrated manner with the terminal device 10. In that case, as a movement performed by the user of the terminal device 10 with respect to the display unit 24, the sensor unit 32 detects a video capturing a movement of the hands of the user. Herein, it is desirable that the sensor unit 32, which is a camera, is installed in such a way that the field of view includes the display surface of the display unit 24 and the hands of the user.

Alternatively, for example, the sensor unit 32 can be a distance sensor that is configured in an integrated manner with the terminal device 10. In that case, as a movement performed by the user of the terminal device 10 with respect to the display unit 24, the sensor unit 32 detects the distance the hands of the user and the display surface of the display unit 24. The distance sensor representing the sensor unit 32 is disposed, for example, in the vicinity of the display surface of the display unit 24. However, that is not the only possible case. When the sensor unit 32 is a LiDAR (which stands for Light Detection and Ranging, or Laser Imaging Detection and Ranging) that is capable of obtaining the distance information distributed in a matrix; the distance information that is distributed in a matrix and that indicates the distance between the hands of the user and the display surface of the display unit 24 can be detected as a movement performed by the user with respect to the display unit 24.

The sensor unit 32 can be a touch sensor that is made of a pressure sensor configured in an integrated manner with the terminal device 10. In that case, the sensor unit 32 is configured in an integrated manner with the display unit 24, and the information about the position at which a hand of the user touches the display screen of the display unit 24 is detected as a movement performed by the user with respect to the display unit 24. When the sensor unit 32 is an optical touch sensor that is capable of responding even when there is no touch of a hand on the display unit 24, the information about whether or not a hand has moved closer to the display unit 24 can be detected as a movement performed by the user with respect to the display unit 24. When the sensor unit 32 is a capacitive touch sensor that is capable of detecting the touch to a plurality of points on the display surface of the display unit 24, the information about a plurality of positions on the display surface of the display unit 24 at which the hands of the user touch can be detected as a movement performed by the user with respect to the display unit 24.

Still alternatively, for example, the sensor unit 32 can be a motion capture sensor. The motion capture sensor representing the sensor unit 32 either can be of the type in which one or more markers (not illustrated) are placed and motion capturing is performed based on the positions of the markers, or can be of the type in which markers are not used. For example, a plurality of markers is placed on a hand of the user. Then, for example, the sensor unit 32 detects motion capture data, such as three-dimensional position information, as a movement performed by the user with respect to the display unit 24.

Still alternatively, for example, the sensor unit 32 can be a camera configured separately from the terminal device 10. In that case, for example, it serves the purpose as long as the camera representing the sensor unit 32 is installed in smart glasses or headsets, which are worn by the user of the terminal device 10, in such a way that the display surface of the display unit 24 of the terminal device 10 is captured either along the line of sight of the user or from the vicinity of the viewing position of the user, such as from the vicinity of the eyes of the user. When the camera placed in the vicinity of the eyes of the user is used as the sensor unit 32, it becomes possible to obtain images that are similar to the field of vision of the user. For that reason, it becomes possible to accurately detect a movement of the hands of the user with respect to the display surface of the display unit 24; and the confidential information can be kept confidential with ease. Alternatively, when the sensor unit 32 is a camera configured separately from the terminal device 10, the camera representing the sensor unit 32 can be attached to the ceiling or a wall inside the room in such a way that the display surface of the display unit 24 of the terminal device 10 is captured. In the abovementioned cases, the terminal device 10 can be configured to obtain the captured video from the sensor unit 32 via the communication unit 30.

The sensor unit 32 can alternatively be configured by combining two or more sensors including the sensors explained above and other types of sensors. For example, when the sensor unit 32 is configured as the combination of a camera installed in the smart glasses being worn by the user and a distance sensor configured in an integrated manner with the terminal device 10, it becomes possible to accurately detect a movement of the hands of the user with respect to the display surface of the display unit 24; and the confidential information can be kept confidential with ease.

The control unit 34 controls the constituent elements of the terminal device 10. For example, the control unit 34 includes an information processing device such as a central processing unit (CPU) or a micro processing unit (MPU), and a storage device such as a RAM or a ROM. The control unit 34 executes a computer program that controls the operations of the terminal device 10 according to the application concerned. Meanwhile, the control unit 34 can alternatively be implemented using an integrated circuit such as an application specific integrated circuit (ASIC) or a field programmable gate array (FPGA). Still alternatively, the control unit 34 can be implemented using a combination of hardware and software.

The control unit 34 includes the movement information obtaining unit 40, a confidentiality-indicating-movement detecting unit 42, and a confidential region processing unit 44.

The movement information obtaining unit 40 controls the sensor unit 32 to detect the movements of the presenter who is presenting information using the terminal device 10. More particularly, the movement information obtaining unit 40 obtains, from the sensor unit 32, movement information indicating a movement that is performed by the presenter with respect to the display unit 24 and that is detected by the sensor unit 32. For example, the movement information obtained by the movement information obtaining unit 40 contains information indicating a movement of the hands of the presenter with respect to the display unit 24.

More particularly, when the sensor unit 32 is a camera, the movement information obtained by the movement information obtaining unit 40 is a video capturing a movement of the hands of the user. When the sensor unit 32 is a distance sensor, the movement information obtained by the movement information obtaining unit 40 indicates the information about one or more distances between the hands of the user and the display surface of the display unit 24. When the sensor unit 32 is a touch sensor, the movement information indicates the information about the positions at which the hands of the user touch the display surface of the display unit 24. When the sensor unit 32 is a motion capture sensor, the movement information obtained by the movement information obtaining unit 40 indicates three-dimensional position information.

Meanwhile, the movement information obtained by the movement information obtaining unit 40 need not be about the presenter. Alternatively, for example, it is possible to obtain the movement information of the person who is using the terminal device 10-2 to view the screen that is shared by the presenter using the terminal device 10-1. That is, the movement information obtaining unit 40 obtains the movement information indicating a movement performed by a person with respect to the display unit 24.

Based on the movement information obtained by the movement information obtaining unit 40, the confidentiality-indicating-movement detecting unit 42 detects whether or not the movement performed by the presenter with respect to the display unit 24 is a confidentiality indicating movement. For example, based on the position of the hands of the presenter with respect to the display unit 24, the confidentiality-indicating-movement detecting unit 42 detects whether or not the movement represents a confidentiality indicating movement. Herein, a confidentiality indicating movement implies a movement used to ensure that the confidential information included in the shared screen is kept confidential. In the present embodiment, a confidentiality indicating movement is a predetermined movement. Regarding the confidentiality indicating movements, the explanation is given later.

In the case in which the display unit 24 of the terminal device 10 is a device such as an HUD that is without a display screen and that projects image information for display, the confidentiality-indicating-movement detecting unit 42 can detect whether or not a movement performed by the presenter with respect to the display range being viewed by the presenter represents a confidentiality indicating movement. In that case, for example, the sensor unit 32 is a camera installed in the smart glasses being worn by the user, and the confidentiality-indicating-movement detecting unit 42 detects a confidentiality indicating movement based on the relationship between the projection surface and a movement of the hands of the user.

In the case in which the movement information obtaining unit 40 also obtains the movement information of another person other than the presenter, the confidentiality-indicating-movement detecting unit 42 detects whether or not a movement performed by the other person, whose movement information is obtained by the movement information obtaining unit 40, with respect to the display unit 24 represents a confidentiality indicating movement. When the presenter belongs to an organization, based on the movement information of the supervisor of the presenter, the confidentiality-indicating-movement detecting unit 42 can detect whether or not a movement performed by the presenter represents a confidentiality indicating movement. In the confidentiality-indicating-movement detecting unit 42, regarding each person who uses the terminal device 10, whether or not the confidentiality indicating movement should be detected can be set in advance.

More particularly, when a video is taken in which a movement of the hands of the user is captured as the movement information, the confidentiality-indicating-movement detecting unit 42 detects, based on the video, whether or not the movement performed by the presenter represents a confidentiality indicating movement. Herein, when the sensor unit 32 is a camera disposed near the eyes of the user, the confidentiality-indicating-movement detecting unit 42 analyzes the video and, based on whether or not at least some part of the display unit 24 is not viewable on account of being overlapped by the hands of the user, detects that the movement performed by the presenter represents a confidentiality indicating movement. Alternatively, when the sensor unit 32 is a camera disposed near the eyes of the user, the confidentiality-indicating-movement detecting unit 42 can perform image correction by taking into account the position of installation of the camera, and then perform image recognition to detect the confidentiality indicating movement. When the area covered by the hands appearing in the video is greater than a threshold value set in advance, the confidentiality-indicating-movement detecting unit 42 determines that the distance from the display surface is equal to or greater than a predetermined distance and determines that the movement is not a confidentiality indicating movement. Thus, the confidentiality-indicating-movement detecting unit 42 can detect a confidentiality indicating movement by taking into account the size of the hands of the user.

When the movement information is about one or more distances between the hands of the user and the display surface of the display unit 24, based on the information about the distances, the confidentiality-indicating-movement detecting unit 42 detects that the movement of the presenter represents a confidentiality indicating movement. For example, based on whether or not the information about the distance between the hands of the user and the display surface of the display unit 24 indicates a shorter distance than a threshold value set in advance, the confidentiality-indicating-movement detecting unit 42 detects that the movement of the presenter represents a confidentiality indicating movement.

When the movement information indicates the position at which the hands of the user touch the display surface of the display unit 24, based on the information about the position, the confidentiality-indicating-movement detecting unit 42 determines that the movement performed by the presenter represents a confidentiality indicating movement. For example, based on whether or not the information about the position at which the hands of the user touch the display surface of the display unit 24 is equal to or greater than a threshold value set in advance, the confidentiality-indicating-movement detecting unit 42 detects that the movement performed by the presenter represents a confidentiality indicating movement.

When the movement information is three-dimensional position information, based on the three-dimensional position information, the confidentiality-indicating-movement detecting unit 42 detects that the movement performed by the presenter represents a confidentiality indicating movement. For example, based on whether or not the distance between the three-dimensional position information of the display unit 24 and the three-dimensional position information of the hands of the user is shorter than a threshold value set in advance, the confidentiality-indicating-movement detecting unit 42 determines that the movement performed by the presenter represents a confidentiality indicating movement.

When the confidentiality-indicating-movement detecting unit 42 detects a confidentiality indicating movement, the confidential region processing unit 44 decides on the confidential region based on the movement information obtained by the movement information obtaining unit 40. Then, the confidential region processing unit 44 performs confidentiality processing with respect to the confidential region, and generates a confidential video.

More particularly, when the movement information indicates a video capturing a movement of the hands of the user, the confidential region processing unit 44 decides on the confidential region based on the video. When the sensor unit 32 is a camera installed near the eyes of the user, the confidential region processing unit 44 analyzes the video and decides on the confidential region based on the region that is not viewable because at least some part of the display unit 24 is overlapped by the hands of the user.

When the movement information indicates one or more distances between the hands of the user and the display surface of the display unit 24, the confidential region processing unit 44 decides on the confidential region based on the information about the distances. For example, the confidential region processing unit 44 decides the confidential region based on the coordinates of the image which is displayed by the display unit 24 and in which the information about the distance between the hands of the user and the display surface of the display unit 24 is assumed to be shorter than a threshold value set in advance.

When the movement information indicates the position at which the hands of the user touch the display surface of the display unit 24, the confidential region processing unit 44 decides on the confidential region based on the information about the position. For example, the confidential region processing unit 44 decides on the confidential region based on the coordinates of the image that is displayed by the display unit 24 corresponding to the information about the position at which the hands of the user touch the display surface of the display unit 24.

When the movement information is three-dimensional position information, the confidential region processing unit 44 decides on the confidential region based on the three-dimensional position information. For example, the confidential region processing unit 44 decides on the confidential region based on the coordinates of the image that is displayed by the display unit 24 corresponding to the three-dimensional position information of the display unit 24 having a short distance to the three-dimensional position information of the hand of the user.

### Confidentiality Indicating Movement and Confidentiality Processing

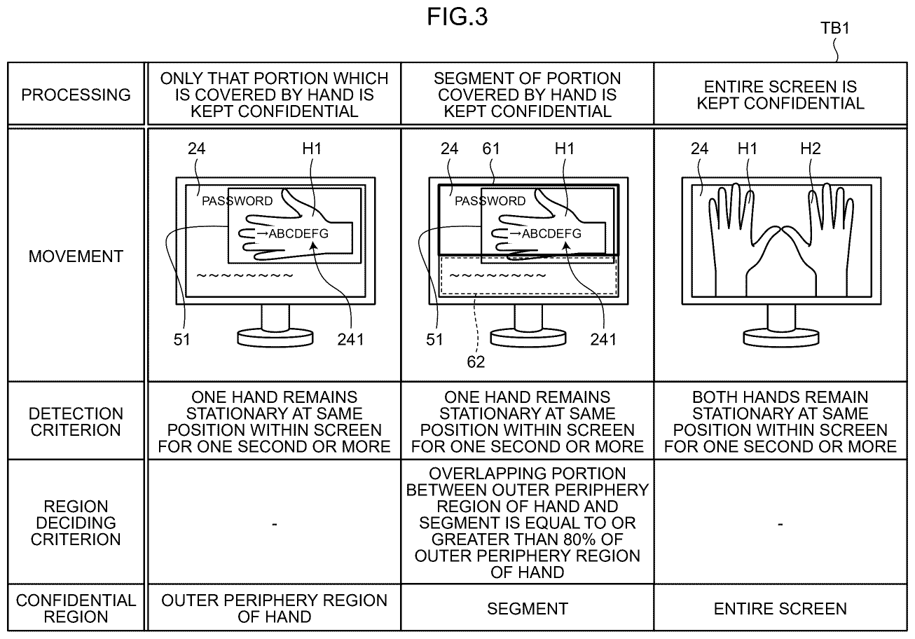

Explained below with reference to FIG. 3 is a confidentiality indicating movement and confidentiality processing according to the embodiment. FIG. 3 is a diagram for explaining a confidentiality indicating movement and confidentiality processing according to the embodiment.

In the embodiment, when the user is giving a presentation by sharing the screen, when the screen includes confidential information that is to be kept confidential from the other users, the confidential information can be kept confidential by performing a confidentiality indicating movement that is instantly executable. More particularly, when the user performs a confidentiality indicating movement, the terminal device 10 performs confidentiality processing for keeping the confidential information confidential. As illustrated in FIG. 3, in the embodiment, there can be three cases regarding the confidentiality indicating movement and the confidentiality processing. However, the confidentiality indicating movement and the confidentiality processing according to the application concerned is not limited to the three cases explained below.

In the first case, only that portion is kept confidential which is covered by a hand of the presenter. In the first case, for example, when the presenter performs a predetermined movement of a hand H1, which is either the right hand or the left hand, with respect to the display surface of the display unit 24, the confidentiality-indicating-movement detecting unit 42 detects that the movement performed by the presenter represents a confidentiality indicating movement. For example, the hand H1 is the palm of a hand or the back of a hand of the presenter. For example, as illustrated in FIG. 3, when the fingers of the hand H1 are spread out, the confidentiality-indicating-movement detecting unit 42 detects that the movement performed by the presenter represents a confidentiality indicating movement. However, in the case of detecting a confidentiality indicating movement, the condition of the hand H1 is not limited to the example given above. Alternatively, the fingers of the hand can be stretched together as in the case of raising the hand, or only an arbitrary finger can be stretched and the other fingers can be folded as in the case of pointing a finger. More particularly, when one hand covers at least some part of the display unit 24 within a predetermined distance in the perpendicular direction from the display surface of the display unit 24 and remains stationary at the same position within the display unit 24 for one second or more, the confidentiality-indicating-movement detecting unit 42 that the movement performed by the presenter represents a confidentiality indicating movement. Regarding covering the display unit 24, the hand of the presenter may or may not be touching the display surface of the display unit 24. Thus, as long as the display unit 24 is covered when viewed from the line of sight of the presenter, it serves the purpose.

More particularly, the confidentiality-indicating-movement detecting unit 42 analyzes a video and, when at least some part of the display unit 24 is not viewable on account of being overlapped by the hand H1 of the user, determines that one hand is covering at least some part of the display unit 24 within a predetermined distance in the perpendicular direction from the display surface. When the information about the distance between the hand H1 and the display surface of the display unit 24 indicates a shorter distance than a threshold value set in advance, the confidentiality-indicating-movement detecting unit 42 can determine that one hand is covering at least some part of the display unit 24 within a predetermined distance in the perpendicular direction from the display surface. Alternatively, when there is information indicating the position at which the hand H1 touches the display surface of the display unit 24, the confidentiality-indicating-movement detecting unit 42 can determine that one hand is covering at least some part of the display unit 24 within a predetermined distance in the perpendicular direction from the display surface. Still alternatively, when the distance between the three-dimensional position information of the display unit 24 and the three-dimensional position information of the hand H1 is shorter than a threshold value set in advance, the confidentiality-indicating-movement detecting unit 42 can determine that one hand is covering at least some part of the display unit 24 within a predetermined distance in the perpendicular direction from the display surface.

Meanwhile, the period of time, for which the hand remains stationary at the same position and which is treated by the confidentiality-indicating-movement detecting unit 42 as one of the criteria for detecting a confidentiality indicating movement, need not be equal to one second, and can be equal to a predetermined period of time. Moreover, in order to detect a confidentiality indicating movement, the criterion about whether or not the hand remains stationary at the same position for a predetermined period of time or more can be substituted with a criterion about whether or not an arbitrary movement is continuously ongoing for a predetermined period of time or more. For example, when it is determined that a movement of waving a hand, that is, waving a hand in a certain direction within a certain range is going on for a predetermined period of time or more, the confidentiality-indicating-movement detecting unit 42 can detect that the movement performed by the presenter represents a confidentiality indicating movement.

When the confidentiality-indicating-movement detecting unit 42 detects a confidentiality indicating movement performed using the hand H, the confidential region processing unit 44 determines that the outer periphery region of the hand H represents a confidential region 51. The outer periphery region of the hand H is a region greater than the region over which the hand H is covering the display surface of the display unit 24 and is, for example, a rectangular region. The confidential region processing unit 44 performs confidentiality processing such as masking with respect to the confidential region 51, and generates a confidential video. In this case, the confidential region processing unit 44 generates a confidential video in which the confidential region 51 is masked, so that a password 241 made of a character string “ABCDEFG” and representing a type of confidential information is kept confidential. Alternatively, when the confidentiality-indicating-movement detecting unit 42 determines that a hand is being waived for a predetermined period of time or more, as compared to the case in which it is determined that the hand is stationary at the same position, the confidential region processing unit 44 can be configured to be able to set a wide range in the direction of hand waving as the confidential region 51.

More particularly, the confidential region processing unit 44 analyzes a video and decides that the outer periphery region of that region in the display unit 24 which is not viewable on account of being overlapped by the hand H represents the confidential region 51. Alternatively, the confidential region processing unit 44 can decide that the confidential region 51 is the outer periphery region of the coordinates of the image which is displayed by the display unit 24 and in which the information about the distance between the hand H and the display surface of the display unit 24 is assumed to indicate a shorter distance than a threshold value set in advance. Still alternatively, the confidential region processing unit 44 decides that the confidential region 51 is the outer periphery region of the coordinates of the image which is displayed by the display unit 24 and which corresponds to the information about the position at which the hand H of the user touches the display surface of the display unit 24. Still alternatively, the confidential region processing unit 44 decides that the confidential region 51 is the outer periphery region of the coordinates of the image which is displayed by the display unit 24 and which corresponds to the three-dimensional position information of the display unit 24 having a short distance to the three-dimensional position information of the hand H.

In the second case, the segment of the portion covered by a hand of the presenter is kept confidential. In this case, the display surface of the display unit 24 is divided in advance into a first segment 61 indicating the upper region and a second segment 62 indicating the lower region. In the second case, in addition to the first case, when the overlapping portion between the confidential region 51 and the first segment 61 is, for example, equal to or greater than 80% of the confidential region 51, the confidential region processing unit 44 determines that the first segment 61 represents the confidential region. Then, the confidential region processing unit 44 performs confidentiality processing such as masking with respect to the first segment 61, and generates a confidential video. In that case, the confidential region processing unit 44 generates a confidential video in which the first segment 61 is masked so that the password 241 representing a type of confidential information is kept confidential. Meanwhile, as a result of comparing a segment region with the confidential region 51, when the confidential region 51 has a greater area, the confidentiality processing can be performed with respect to the confidential region 51. That is, the confidentiality processing according to the first case can be performed.

In the third case, the entire display screen of the display unit 24 is kept confidential. In this case, for example, when the presenter performs a movement using both hands H1 and H2 with respect to the display unit 24, the confidentiality-indicating-movement detecting unit 42 detects that the movement performed by the presenter represents a confidentiality indicating movement. More particularly, when both hands remain stationary at the same position within the display unit 24 for one second or more, the confidentiality-indicating-movement detecting unit 42 detects that the movement performed by the presenter represents a confidentiality indicating movement. When the confidentiality-indicating-movement detecting unit 42 detects a confidentiality indicating movement using both hands, the confidential region processing unit 44 decides that the entire display screen represents the confidential region. Then, the confidential region processing unit 44 performs confidentiality processing such as masking with respect to the entire display screen, and generates a confidential video. In that case, the entire display page in which the shared material is displayed gets masked. Thus, based on the number of palms of the hands or the number of backs of the hands covering the display unit 24, the confidential region processing unit 44 decides on the confidential region.

With reference to the example illustrated in FIG. 3, the explanation is given for the case in which a movement of hands represents a confidentiality indicating movement. However, the application concerned is not limited to that example. Alternatively, for example, a confidentiality indicating movement can be a movement of covering some part of the display unit 24 with the fingers of the user. In that case, for example, the confidential region processing unit 44 can set the outer periphery region of the fingers as the confidential region, and can perform masking.

Still alternatively, for example, a confidentiality indicating movement can be a movement performed to cover the display unit 24 using an object such as a notebook present around the user of the terminal device 10. However, from the perspective of being able to keep the confidential information confidential using an instant movement or from the perspective of preventing an erroneous movement, it is desirable to use the movement of the palm of a hand or the back of a hand. Meanwhile, from among the movement of the palm of a hand, the movement of the back of a hand, the movement of the fingers, and the movement of an object; the user can be enabled to arbitrarily set the movement to be treated as a confidentiality indicating movement. For example, from among the movement of the palm of a hand, the movement of the back of a hand, the movement of the fingers, and the movement of an object; the user can be enabled to arbitrarily set at least one movement to be treated as a confidentiality indicating movement.

In the application concerned, the explanation is given about the case in which the confidential region is rectangular in shape. Alternatively, for example, the confidential region can have a polygonal shape other than the rectangular shape, such as the circular shape or the elliptical shape.

### Confidentiality Processing

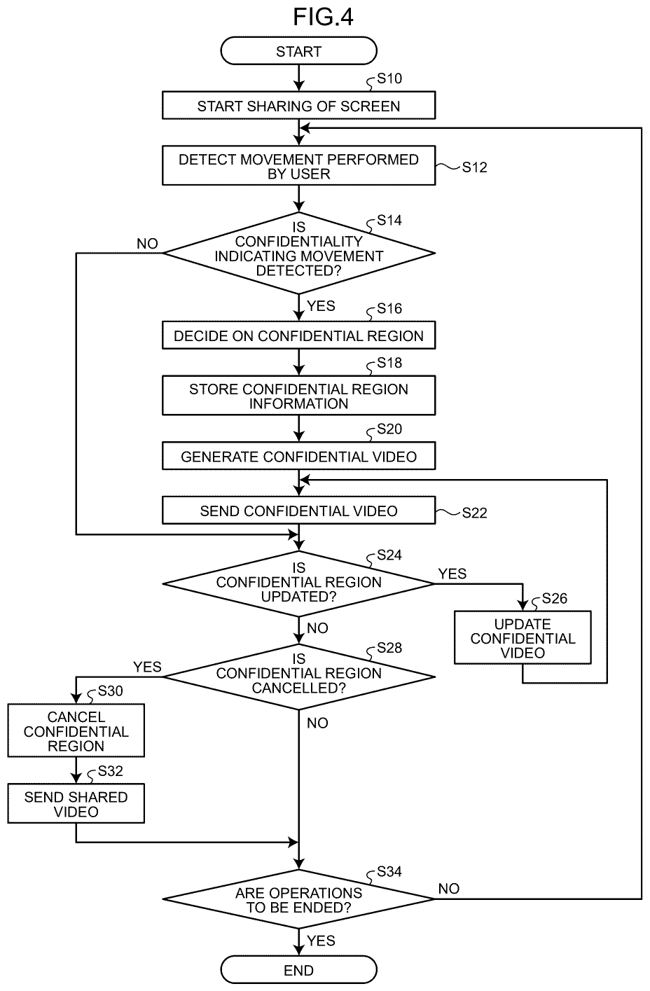

Explained below with reference to FIG. 4 is the confidentiality processing according to the embodiment. FIG. 4 is a flowchart for explaining a flow of the confidentiality processing according to the embodiment.

The operations illustrated in FIG. 4 indicate the flow of operations performed in the terminal device 10 used by the presenter during an online meeting.

The control unit 34 starts sharing the screen among the terminal devices 10 of the users participating in the online meeting (Step S10). When the control unit 34 starts sharing the screen among a plurality of terminal devices 10, the same material gets shared among the terminal devices 10. Then, the system control proceeds to Step S12. The movement information obtaining unit 40 controls the sensor unit 32 to detect a movement performed by the user of the terminal device 10 (Step S12). For example, while the online meeting is going on, the movement information obtaining unit 40 can cause the sensor unit 32 to constantly detect the movements performed by the user. In the following explanation, it is assumed that the sensor unit 32 is a camera installed in the smart glasses being worn by the user, and the movement information obtaining unit 40 causes the camera to take a video of the display unit 24 so that a movement of the hands of the user with respect to the display unit 24 is captured. Then, the movement information obtaining unit 40 obtains the video, which is taken by the sensor unit 32, as the movement information. Subsequently, the system control proceeds to Step S14.

Based on the movement information obtained by the movement information obtaining unit 40, the confidentiality-indicating-movement detecting unit 42 determines whether or not a confidentiality indicating movement is detected (Step S14). When a confidentiality indicating movement is detected (Yes at Step S14), the system control proceeds to Step S16. When a confidentiality indicating movement is not detected (No at Step S14), the system control proceeds to Step S24 and an operation of determining whether or not the confidential region is updated is performed at Step S24 (explained later).

When the determination at Step S14 is affirmative, the confidential region processing unit 44 decides on the confidential region based on the movement information obtained by the movement information obtaining unit 40 (Step S16). More particularly, based on the video obtained by the movement information obtaining unit 40, the confidential region processing unit 44 identifies the region of the display unit 24 which is covered by a hand of the user of the terminal device 10, and treats the identified region as the confidential region. Then, the system control proceeds to Step S18.

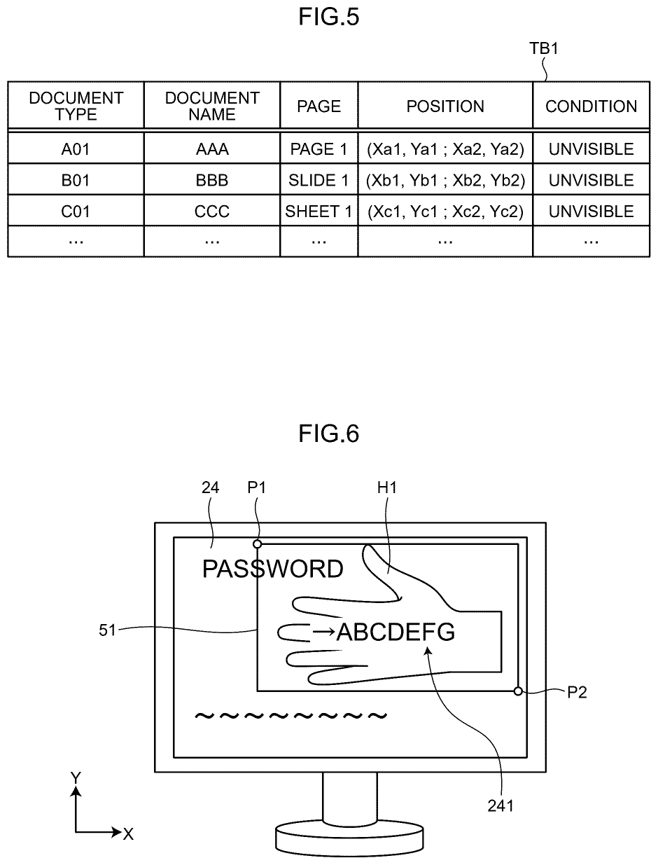

The confidential region processing unit 44 stores confidential region information, which indicates the identified confidential region, in the memory unit 28 (Step S18). FIG. 5 is a diagram illustrating an example of the confidential region information according to the embodiment. As illustrated in FIG. 5, a table TB1 is a table for managing the confidential region information. The table TB1 includes items such as “document type”, “document name”, “page”, “position”, and “condition”. In the case in which the segment of the portion covered by a hand of the presenter is to be kept confidential, an item “segment” indicating the segment can also be added in the confidential region information.

The item “document type” indicates the naming of the application that created the material to be shared. For example, the item “document type” includes conceptual naming such as “A01”. However, in practice, the specific naming of the application is given. Meanwhile, the item “document type”can be a web browser too.

The item “document name” indicate the file name of the material to be shared. For example, the item “document name” includes a conceptual name such as “AAA”. However, in practice, a specific file name, an extension, and a URL (Uniform Resource Locator) are given.

The item “page” includes that page number in the provided material in which a confidential region is included. For example, the item “page” indicates naming such as “page 1”, “slide 1”, and “sheet 1” corresponding to the applications that created the material to be shared. When the shared material is a webpage, the item “page” can indicate, for example, the subdirectory of a URL.

The item “position” indicates the position of a confidential region. For example, the item “position” indicates the coordinates of a confidential region in the material to be shared. FIG. 6 is a diagram for explaining the coordinates of a confidential region according to the embodiment. As illustrated in FIG. 6, the position of the rectangular confidential region 51 is identified by the position coordinates of two points. For example, the position of the confidential region 51 is identified by the position coordinates of two vertices, namely, a top left vertex P1 and a bottom right vertex P2. For example, in FIG. 5, it is illustrated that the material having “AAA” as the “document name” has “(Xa1, Ya1; Xa2, Ya2)” as the “position” of the confidential region. In that case, the first coordinates (Xa1, Ya1) represent the coordinates of the vertex P1 illustrated in FIG. 6, and the second coordinates (Xa2, Ya2) represent the coordinates of the vertex P2 illustrated in FIG. 6.

The item “condition” indicates the present condition of a confidential region. For example, “UNVISIBLE” indicates that the concerned confidential region is not viewable in the other terminal devices 10. When a confidential region is visible in the other terminal devices 10, “VISIBLE” can be specified in the item “condition”.

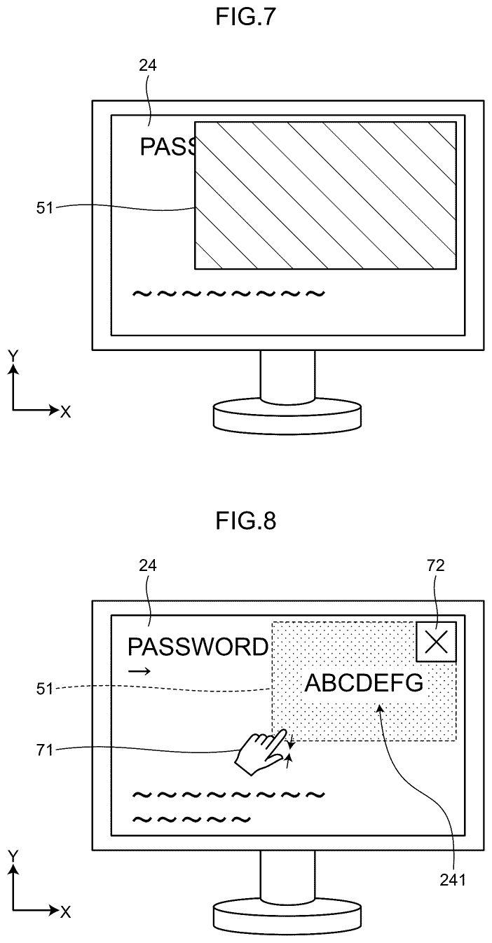

Returning to the explanation with reference to FIG. 4, the confidential region processing unit 44 performs confidentiality processing with respect to the identified confidential region, and generates a confidential video (Step S20). Then, the system control proceeds to Step S22. The confidential region processing unit 44 sends the confidential video to the other terminal devices 10 via the communication unit 30 (Step S22). FIG. 7 is a diagram for explaining a confidential video that is displayed in another terminal device 10 according to the embodiment. As illustrated in FIG. 7, in the other terminal device 10, the confidential region 51 including the confidential information is in the masked state. Hence, the user of the other terminal device 10 cannot see the confidential information such as a password. Moreover, the confidential region information indicating the confidential region is stored in the memory unit 28. Hence, for example, even when the page of the shared material changes and returns to the page including the confidential information, the confidential region 51 remains in the masked state. As a result, in the embodiment, the confidential information can be kept confidential in a more appropriate manner. Then, the system control proceeds to Step S24.

The confidential region processing unit 44 determines whether or not the confidential region is updated (Step S24). FIG. 8 is a diagram for explaining a method for updating the confidential region according to the embodiment. In FIG. 8 is illustrated the display screen displayed in the display unit 24 of the terminal device 10 of the presenter. As illustrated in FIG. 8, in the terminal device 10 of the presenter, in order to enable confirmation of the character string of the password 241 included in the confidential region 51, for example, an image layer having the transparency of 50% is synthesized and displayed. For that reason, the user becomes able to easily understand that region of the display screen which is kept confidential. For example, the user can operate the mouse to drag a pointer 71 in alignment with the end portions of the confidential region 51, and accordingly can expand or narrow the confidential region 51. Moreover, for example, the user can operate the mouse to drag the pointer 71 in alignment with a predetermined region of the confidential region 51, and accordingly can change the position of the confidential region 51. When the size of the confidential region 51 is changed or when the position of the confidential region 51 is changed, the confidential region processing unit 44 determines that the confidential region is updated. Meanwhile, the configuration can be such that, unless the mouse is operated and is held down with the pointer 71 remaining in alignment with a predetermined region of the confidential region 51, the confidential region 51 cannot be updated. That is, the configuration can be such that the confidential region 51 can be switched to the active state by holding down the mouse over it. When it is determined that the confidential region is updated (Yes at Step S24), the system control proceeds to Step S26. However, when it is not determined that the confidential region is updated (No at Step S24), the system control proceeds to Step S28.

When the determination at Step S24 is affirmative, the confidential region processing unit 44 updates the confidential video (Step S26). More particularly, the confidential region processing unit 44 changes the confidential region according to a user operation and thus updates the confidential region. Then, the system control returns to Step S22. That is, as a result of updating the confidential video, the confidential video displayed in the other terminal devices 10 also gets updated.

When the determination at Step S24 is negative, the confidential region processing unit 44 determines whether or not the confidential region is cancelled (Step S28). As illustrated in FIG. 7, a button 72 is provided at the top right end of the confidential region 51. For example, the user can operate the mouse and click it while keeping the pointer 71 over the button 72, so that the confidential region 51 can be cancelled. When the confidential region 51 is cancelled by the user, the confidential region processing unit 44 determines that the confidential region has been cancelled. When it is determined that the confidential region has been cancelled (Yes at Step S28), the system control proceeds to Step S30. On the other hand, when it is not determined that the confidential region has been cancelled (No at Step S28), the system control proceeds to Step S34.

When the determination at Step S28 is affirmative, the confidential region processing unit 44 cancels the confidential region (Step S30). Then, the system control proceeds to Step S32.

The confidential region processing unit 44 sends the shared video, from which the confidential region is cancelled, to the other terminal devices 10 (Step S32). As a result, the other terminal devices 10 display the shared video, from which the confidential region is cancelled, in the corresponding display units 24. Then, the system control proceeds to Step S34.

The control unit 34 determines whether or not to end the operations (Step S34). For example, when the online meeting gets over, the control unit 34 determines to end the operations. When it is determined to end the operations (Yes at Step S34), the operations illustrated in FIG. 4 are ended. However, when it is not determined to end the operations (No at Step S34), the system control returns to Step S12 and the operations are performed again.

As explained above, according to the present embodiment, when the material to be shared during an online meeting contains confidential information, the presenter can perform a simple and instantly-executable movement by which the confidential information can be kept confidential. As a result, according to the present embodiment, a simple movement makes it possible to prevent leakage of the confidential information.

The constituent elements of the device illustrated in the drawings are merely conceptual, and need not be physically configured as illustrated. The constituent elements, as a whole or in part, can be separated or integrated either functionally or physically based on various types of loads or use conditions. Moreover, a configuration based on such separation/integration can be achieved in a dynamic manner.

According to the application concerned, the confidential information that is included in the shared screen during an online meeting can be kept confidential with ease.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal device comprising:
a display unit that displays information;
a movement information obtaining unit that obtains movement information indicating a movement performed by a person with respect to the display unit which displays the information;
a confidentiality-indicating-movement detecting unit that, based on the movement information, detects whether or not a movement performed by the person with respect to the display unit represents a confidentiality indicating movement; and
a confidential region processing unit that, when the confidentiality-indicating-movement detecting unit detects the confidentiality indicating movement, decides on a confidential region based on the movement information obtained by the movement information obtaining unit, and generates a confidential video based on the confidential region.

2. The terminal device according to claim 1, wherein
movement information obtained by the movement information obtaining unit contains information indicating a movement of a hand of the person with respect to the display unit, and
based on position of the hand of the person with respect to the display unit, the confidentiality-indicating-movement detecting unit detects the confidentiality indicating movement.

3. The terminal device according to claim 2, wherein,
based on whether the display unit is covered from the line of sight of the person, as determined by the position of the hand of the person with respect to the display unit, the confidentiality-indicating-movement detecting unit detects the confidentiality indicating movement, and
based on the region of the display unit that cannot be seen from the line of sight of the person due to being covered by the hand of the person, the confidential region processing unit decides on the confidential region.

4. The terminal device according to claim 2, wherein, when at least some part of the display unit is covered by a hand of the person for a predetermined period of time or more, the confidentiality-indicating-movement detecting unit detects that movement information obtained by the movement information obtaining unit represents the confidentiality indicating movement.

5. The terminal device according to claim 2, wherein, based on number of hands covering the display unit or based on position of a hand covering the display unit, the confidential region processing unit decides on the confidential region in movement information obtained by the movement information obtaining unit.

6. The terminal device according to claim 4, wherein,
the confidential region processing unit decides the confidential region of an outer periphery region of the hand of the parson.

7. The terminal device according to claim 4, wherein,
the confidential region processing unit divides the display surface of the display unit into multiple segments and decides the confidential region based on the ratio of overlap between the segments and an outer periphery region of the hand of the parson.

8. The terminal device according to claim 4, wherein,
when both hands cover the display unit, the confidential region processing unit decides an entire display screen of the display unit represents the confidential region.

9. The terminal device according to claim 1, wherein the movement information obtaining unit obtains the movement information from a camera that takes an image of display surface of the display unit from vicinity of viewing position of a user.

10. A control method comprising:
obtaining movement information that indicates a movement performed by a person with respect to a display unit which displays information;
detecting, based on the movement information, whether or not a movement performed by the person with respect to the display unit represents a confidentiality indicating movement; and
generating that, when the confidentiality indicating movement is detected, includes deciding on a confidential region based on the movement information, and generating a confidential video based on the confidential region.
